(19) United States
(12) Patent Application Publication
(10) Pub. No.: US 2014/0129441 A1
(43) Pub. Date: May 8, 2014

(54) SYSTEMS AND METHODS FOR AUTHORIZING SENSITIVE PURCHASE TRANSACTIONS WITH A MOBILE DEVICE

(71) Applicants: German Blanco, London (GB); Colin Tanner, Uxbridge (GB); Sandra Jansen, London (GB)

(72) Inventors: German Blanco, London (GB); Colin Tanner, Uxbridge (GB); Sandra Jansen, London (GB)

(21) Appl. No.: 13/667,648

(22) Filed: Nov. 2, 2012

(51) Int. Cl. G06Q 20/40

(52) U.S. Cl. 705/44

(57) ABSTRACT

Systems, apparatus and methods are presented that enable an issuer financial institution (FI) to contact a financial account holder concerning a possibly fraudulent purchase transaction via a non-intrusive notification transmitted to a mobile device. An embodiment includes receiving, by the cardholder's mobile device, a transaction alert message, providing an indication of the transaction alert message, and displaying transaction alert information along with a validate indicator and a decline indicator. The process also includes receiving a selection of the validate indicator, prompting the cardholder to enter a mobile personal identification number (mPIN), validating the mPIN, and then transmitting a validation signal to an issuer FI.

### FIELD

The present invention generally relates to systems and methods for enabling an issuer financial institution (FI) to contact a consumer (cardholder) concerning a questionable or possibly fraudulent purchase transaction via a non-intrusive notification transmitted to the consumer's mobile device. In response to the notification, the cardholder can accept or decline the purchase transaction by interacting with one or more menus provided on his or her mobile device.

### BACKGROUND

Payment cards such as credit or debit cards are ubiquitous and for decades such cards have included a magnetic stripe on which the relevant account number is stored. To consummate a purchase transaction with such a card, the card is swiped through a magnetic stripe reader that is part of the point of sale (POS) terminal. The reader reads the account number from the magnetic stripe. The account number is then used to route a transaction authorization request that is initiated by the POS terminal.

A prominent payment card system is operated by the assignee hereof, MasterCard International Incorporated, and by its member financial institutions. In a typical purchase transaction, a consumer visits a retail store operated by a merchant, selects goods that he or she wishes to purchase, carries the goods to the merchant's POS terminal, and presents his or her payment card. The POS terminal reads data such as the customer's payment card account number from the payment card and sends an authorization request to an acquirer financial institution (FI) with which the merchant has a relationship. The authorization request typically includes data such as the payment card account number, the amount of the transaction, the time of day, some details of the merchant's store, and other information. The authorization request is routed via a payment card system (which may be, for example, the well-known Banknet system operated by the assignee hereof) to the issuer financial institution (FI) that issued the customer's payment card. If all is in order, the issuer FI transmits a favorable authorization response to the POS terminal through the payment card system and via the acquirer FI. The transaction at the POS terminal is then completed and the customer leaves the store with the goods. A subsequent clearing transaction initiated by the merchant results in a transfer of the purchase transaction amount from the customer's payment card account to an account that belongs to the merchant.

A drive for greater convenience and more rapid transactions at POS terminals has resulted in the development of payment cards that allow the account number to be automatically read from the card by radio frequency (RF) communication between the card and a proximity reader which may be incorporated with the POS terminal. Such cards are often referred to as “proximity payment cards” or “contactless payment cards”, and contain a radio frequency identification (RFID) integrated circuit (IC) or tag that is embedded in the card body. A suitable antenna is also embedded in the card body and is connected to the RFID IC (or chip) to allow the chip to receive and transmit data by RF communication via the antenna. In typical arrangements, the RFID IC is powered by an RF interrogation signal that is transmitted by the proximity reader and received by the card antenna.

MasterCard International Incorporated, the assignee hereof, has established a widely-used standard known as “PayPass” for interoperability of contactless payment cards and proximity readers. In the PayPass system, at checkout a tiny microchip and a radio antenna embedded in a PayPass-enabled device wirelessly transmits payment details to a PayPass reader when the PayPass-enabled device is brought into close proximity (by “tapping” the device on a pre-set location) to the reader. The proximity reader associated with the POS terminal then verifies the transaction with the issuer FI through, for example, MasterCard's reliable network and indicates approval. The PayPass reader includes a keypad that allows a cardholder to enter a Personal Identification Number (PIN) used by the payment system to authenticate the cardholder. It should be understood, however, that other types of wireless protocols for the wireless exchange of information have been established, such as Near-Field Communication (NFC), for payment applications.

The capabilities of a proximity payment card (or a contactless payment card) have recently been incorporated into portable or mobile devices, thereby turning such mobile devices into contactless payment devices. Such a contactless payment devices typically includes integrated circuitry with the same or similar functionality as the RFID IC of a contactless payment card and include an antenna. Examples of payment-enabled mobile devices include, but are not limited to, mobile telephones, tablet computers, key fobs, portable digital music players, personal digital assistants (PDAs) and the like.

Internet shopping is now common, and online shopping websites and/or merchants encourage online shopping by offering discount prices and by promoting free-shipping or reduced fee shipping options. Internet transactions are typically conducted by consumers entering credit card, debit card and/or gift card data into a checkout screen of a merchant's website (often referred to as “card not present” transactions). Such purchase transaction checkout procedures typically only require a credit card number, expiration date and CVC2 code data entry from the consumer to process a transaction.

Payment card fraud sometimes occurs, and costs financial institutions, consumers and merchants a significant amount of money each year. Thus, financial institutions have increasingly sought to improve security measures including utilizing computer systems that run complex statistical modeling programs to analyze transactions for signs of fraud. In many cases, the fraud-detection programs are “self-learning”, which means that the programs teach themselves over time which behaviors and situations are normal for a particular consumer and which are not by using consumer data such as spending patterns and the like. Some of these anti-fraud programs build up a database of information concerning how, when and where each consumer shops. Such data is then analyzed to determine whether or not a current transaction fits the expected or usual pattern. For new credit card customers, since there is not much information to work with initially, a method called “peer profiling” may be used which compares that new credit card customer's transactions with those made by people of similar age and income who reside in the same or similar geographic area to flag any potential fraudulent activity. Payment card issuers may also impose certain rules on the anti-fraud software to spot potentially fraudulent use of a payment card account. For example, if a few very small transactions are followed by one or more very large transactions then those transactions for that payment card account may be flagged because it has been observed that thieves often “test” a stolen credit card account number with a small purchase before buying something expensive. In another example, if the cardholder logs into his or her bank account from a home computer in California and minutes later someone uses that same cardholder's bank-issued payment card in a shop in Mexico, then that payment card account may be flagged for potential fraudulent activity as it appears that the cardholder is in two places at one time.

When an issuer financial institution or other entity flags a potential fraudulent transaction, the fraud-detection software may be configured to suspend, block or freeze a payment card account until the issuer can contact the cardholder to verify that one or more transactions are not fraudulent. Typically, when a payment card transaction is flagged by an issuer bank's anti-fraud system as possibly being fraudulent, a representative of the issuer bank calls the cardholder by telephone to confirm that the flagged transaction should (or should not) be authorized. However, this process is not always efficient as the cardholder may not be available to pick up the call. Using the example mentioned above concerning a cardholder who has logged into his bank account from a home computer in California and minutes later someone used that same cardholder's bank-issued payment card in a shop in Mexico, if the person using that payment card account in Mexico is the cardholder's daughter who is using an authorized card while on spring break, then she will not be happy that the payment card account has been blocked. Furthermore, if the cardholder is unavailable to receive a telephone call from the issuer financial institution, then the cardholder's daughter can be placed in an uncomfortable and potentially dangerous situation if she cannot complete the transaction or utilize that payment card for another transaction.

Consumers can also be notified about a transaction that has occurred by e-mail to an e-mail account provided by the consumer to his or her payment account issuer, and/or via short-messaging service (SMS) to the cardholder's mobile telephone. (An SMS message is a text message that can be sent from one cell phone to another or from an entity such as a financial institution to a customer's cell phone.) However, an e-mail message may also not adequately protect a cardholder from a fraudulent transaction because he or she may not have internet access at the time of the fraud and thus not have access to e-mail, and some cardholders may decline to utilize SMS message notifications because such messaging can be intrusive. In addition, consumers are leery of receiving bogus fraud alerts, which typically include a fraudulent return phone number and/or link to a fraudulent website, which fraudsters have learned can be a great way to trick cardholders into providing sensitive financial account information.

Thus, there is a need for providing a cardholder with a non-intrusive, secure process for validating a questionable or dubious purchase transaction that has been flagged by an issuer as being potentially fraudulent, and to do so in real-time by using his or her mobile device, such as a mobile telephone. In addition, there is a need for providing a cardholder with a method for securely pre-authorizing purchase transactions from his or her mobile device so that the card issuer financial institution will not flag a particular questionable purchase transaction as being possibly fraudulent.

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments (not necessarily drawn to scale), wherein:

FIG. 1 is a block diagram illustrating a transaction-handling system in accordance with an embodiment of the invention;

FIG. 2 is a block diagram of the components of a mobile telephone for use in accordance with some embodiments of the invention;

FIG. 3 is a block diagram illustrating certain aspects of software that may include one or more application programs according to an embodiment of the invention;

FIG. 4 is a flowchart illustrating a post-authorization process according to an embodiment of the invention;

FIGS. 5A and 5B illustrate examples of screen shots shown on a display screen of a cardholder's mobile device with regard to a post-authorization mode of operation according to an embodiment of the invention;

FIGS. 6A and 6B illustrate examples of screen shots shown on a display screen of a cardholder's mobile device with regard to a pre-authorization mode of operation according to an embodiment of the invention; and

FIG. 7 is a block diagram of an authorization server computer according to an embodiment of the invention.

### DETAILED DESCRIPTION

In general, and for the purpose of introducing concepts of novel embodiments described herein, provided are systems, apparatus and methods for enabling an issuer financial institution (FI) to contact a consumer or an account holder (such as a cardholder) concerning a questionable or possibly fraudulent purchase transaction via a non-intrusive notification transmitted to an application resident on the mobile device of the consumer and/or cardholder. The notified cardholder can then accept or decline the transaction by interacting with one or more menus on his or her mobile device so as to cause the mobile device to transmit a verification indication or a decline indication to the issuer FI. In some implementations, the process includes the cardholder providing an indication validating a purchase transaction and then being prompted to enter a secret mobile personal identification number (mPIN) that must be verified before a signal or message is sent to the issuer FI that indicates that the questionable purchase transaction is legitimate.

Furthermore, in some embodiments the mobile device application permits the cardholder to notify or warn the bank in advance that one or more “special” transactions will take place that should not be flagged as potentially fraudulent. This pre-authorization procedure may be conducted directly from the cardholder's mobile device and may be stored in a storage device associated with an electronic anti-fraud system of the issuer FI, for example.

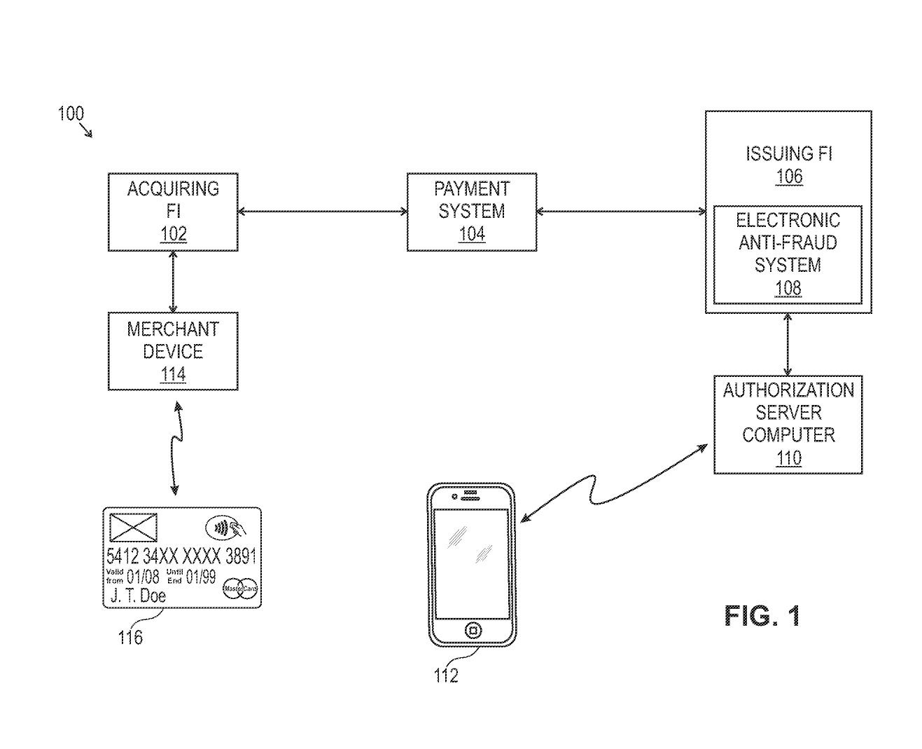

FIG. 1 is a block diagram that illustrates an embodiment of a transaction-handling system 100. The transaction-handling system 100 includes an acquirer financial institution (FI) 102, a payment system 104, an issuer FI 106 and an authorization server computer 110. Block 102 may be considered to represent both the acquiring FI and a computer (not separately indicated) that handles the acquirer functions for purchase transactions in a conventional payment card system. Except for certain modifications described herein, the acquirer computer 102 may function in a generally conventional manner.

The payment system 104 may operate in a conventional manner to route purchase transaction authorization requests from acquirers to issuers, and to route purchase transaction authorization responses back from the issuers to the acquirers. A separate system for clearing purchase transactions may also be provided by the operator of the payment system 104 which is not indicated in FIG. 1 for the sake of simplicity. An example of a suitable payment system is the “Banknet” system operated by MasterCard International Incorporated, the assignee hereof.

Block 106 may be considered to represent the issuer financial institution (FI) and its computer and/or computer systems by which it participates in the payment card system. The issuer FI computer 106 may operate in a conventional manner to receive authorization requests via the payment system 104 and to transmit authorization responses back to the acquirer FI 102 via the payment system 104. In some implementations, the issuer FI 106 includes an electronic anti-fraud system 108, which may be an application program running on one or more server computers. The anti-fraud system 108 is operable to analyze purchase transaction data, cardholder data and/or other forms of data to determine and/or predict when a possibly fraudulent transaction is being attempted with regard to a consumers' financial account (for example, a purchase transaction may be considered to be dubious or possibly fraudulent if it includes a very expensive luxury item which does not match a spending profile of a particular cardholder who owns the financial account). In some embodiments, the issuing FI 106 is operably connected to an authorization server computer 110 which is operable to receive alerts (which will be explained below) from the electronic anti-fraud system 108 of the issuing FI 106. The authorization server computer 110 is also operable to communicate with a mobile device 112 (depicted in FIG. 1 as a mobile telephone) that belongs to the cardholder or the financial account holder. It should be understood, however, that the mobile device may comprise devices other than mobile telephones, such as a tablet computer (such as an iPad™), a laptop computer, a key fob, a personal digital assistant (PDA), a portable music player (such as an iPod Touch™), and the like.

Also shown in FIG. 1 is a merchant device 114 from which a purchase transaction is initiated for processing by the transaction-handling system 100. (Although only one merchant device 114 is shown in FIG. 1, in practice there may be a large number of merchant devices that may from time to time transmit purchase transaction authorization requests to the acquirer FI computer 102.) The merchant device 114 may be, for example, a point of sale terminal and associated reader device or a commerce-enabled mobile telephone that is operable to, for example, read financial data from a cardholders' payment device 116. The payment device 116 may be a credit card or debit card or pre-paid card having a magnetic stripe, or may be a proximity payment card or proximity device that contains an RFID chip and antenna for transmitting financial data to a proximity reader (not shown) associated with the merchant device 114. In some embodiments, the cardholder's mobile device 112 may be a payment-enabled device that is operable to conduct purchase transactions, in which case the payment device 116 need not be utilized.

FIG. 1 shows only components of the transaction-handling system 100 that are involved in handling one transaction. It should be understood, however, that in practice the transaction-handling system 100 may include many more acquiring FI computers than the single acquirer FI computer 102 shown in FIG. 1, and may include many more issuer FI computers than the single issuer FI computer 106 depicted in FIG. 1.

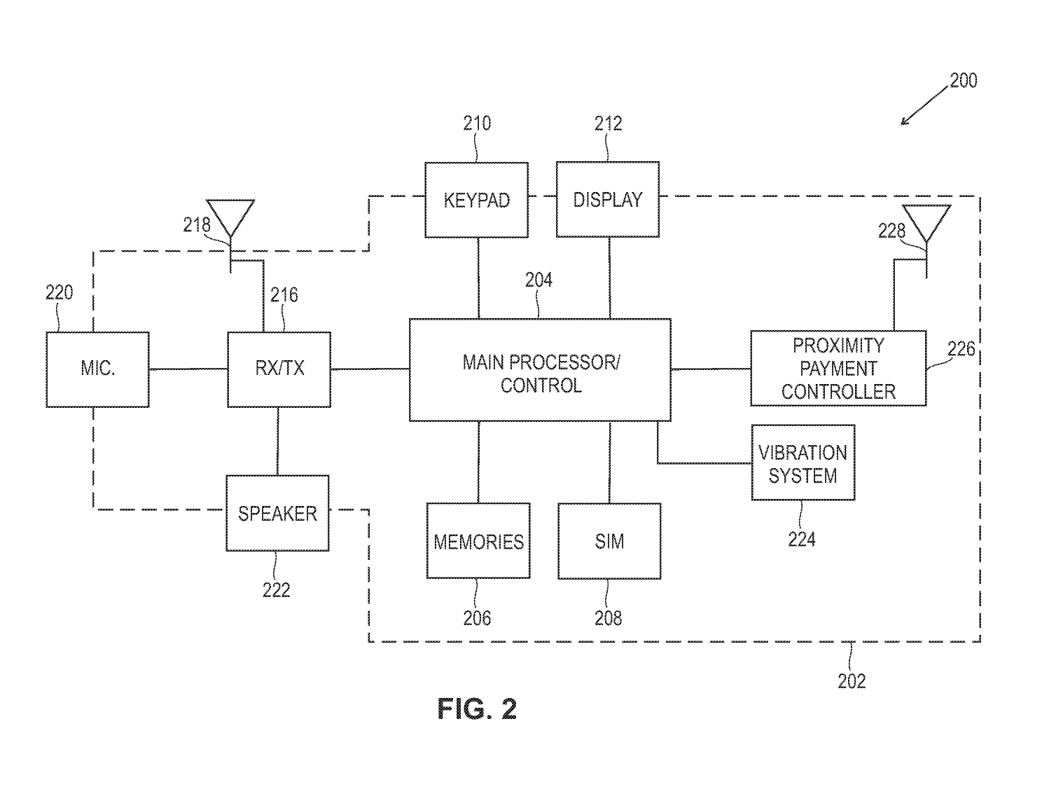

FIG. 2 is a block diagram of the components of a mobile telephone 200 for use in accordance with some embodiments described herein. The mobile telephone 200 may serve as the cardholder's mobile device 112 shown in FIG. 1, and may also (but need not) have capabilities for functioning as a contactless payment device. In its hardware aspects the components of the mobile telephone 200 may be entirely conventional, and the mobile telephone may also be conventional in its software aspects. But the mobile telephone 200 may be configured to provide novel functionality as described herein through interaction, for example, via a conventional browser with a web page that supports one or both of a post-authorization process and/or a pre-authorization process. In some embodiments, however, novel functionality as described herein may result at least partially from software and/or firmware that programs the mobile telephone 200 to support one or both of a post-authorization process and/or a pre-authorization process.

The mobile telephone 200 may include a conventional housing (indicated by dashed line 202) that contains and/or supports the other components of the mobile telephone 200. The mobile telephone 200 further includes conventional control circuitry 204 for controlling over-all operation of the mobile telephone 200. In some implementations, the control circuitry 204 is suitably programmed to allow the mobile telephone 200 to engage in data communications and/or text messaging with other devices, and to allow for interaction with web pages accessed via browser software, which is not separately shown. Other components of the mobile telephone 200, which are in communication with and/or controlled by the control circuitry 204, include one or more memory devices 206 (for example, program and working memory, and the like); a conventional SIM (subscriber identification module) card 208; a conventional key pad 210 (or touch screen) for receiving user input; and a display 212 (which may again be a touch screen) for displaying output information to the user.

The mobile telephone 200 also includes conventional receive/transmit circuitry 216 that is also in communication with and/or controlled by the control circuitry 204. The receive/transmit circuitry 216 is coupled to an antenna 218 and provides the communication channel(s) by which the mobile telephone 200 communicates via a mobile network (not shown). The mobile telephone 200 further includes a conventional microphone 220, coupled to the receive/transmit circuitry 216. Of course, the microphone 220 is for receiving voice input from the user. A loudspeaker 222 is also included to provide sound or audio output to the user, and is coupled to the receive/transmit circuitry 216. In addition, a vibration system 224 is provided for use to alert the mobile telephone user of an incoming message.

The mobile telephone 204 may also include an integrated circuit (IC) or chipset 226 of the kind embedded in contactless payment cards. For example, an RFID IC 226 is connected to an antenna 228 and operates so as to interact with, for example, an RFID/NFC proximity reader of a POS terminal to provide a payment card account number and other information for a purchase transaction at the POS terminal. For example, the RFID chip 226 may be designed and/or programmed to operate in accordance with the well-known “PayPass” standard (promulgated by the assignee hereof) for contactless payment applications.

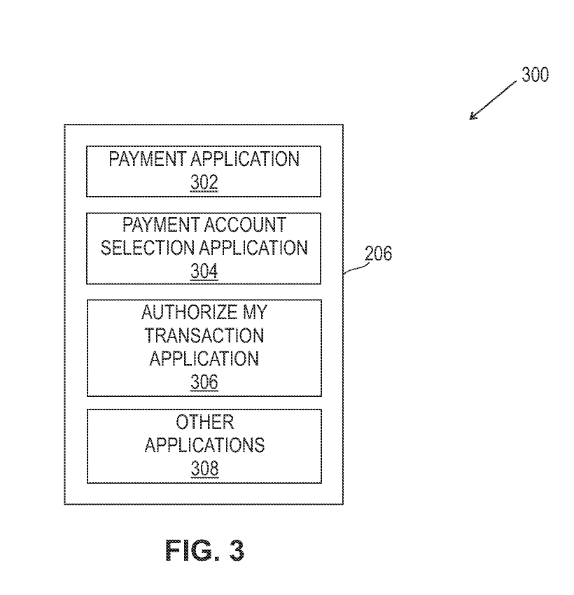

FIG. 3 is a block diagram 300 that illustrates certain aspects of software that may include one or more application programs, and that may be stored, for example, in the storage device or memories 206 of the mobile telephone 200 of FIG. 2. The application programs may be configured to provide functionality in accordance with the methods described herein to control the main processor 204 and/or the payment controller 226. Constituent elements of an “Authorize My Transaction” function and/or an electronic wallet function may have been downloaded, for example, from the authorization server 110 of FIG. 1 and/or from a wallet server (not shown) and stored in the memories 206 for implementation by a consumer's mobile device (such as a payment-enabled mobile telephone, tablet computer, or laptop and the like). In general, an electronic wallet application functions to obtain and store a consumer's payment account data and/or other credentials to carry out financial transactions, for example, to purchase products from online merchants and/or from retail stores. Such an electronic wallet application may be stored in a cardholder's mobile device, and/or may be stored in a wallet server computer (not shown) that may be accessed, for example, via the internet while performing an online transaction.

Referring again to FIG. 3, block 302 represents a payment application program that allows the cardholder (consumer) to store and manage payment account information in his or her mobile device, for example a payment-enabled mobile telephone, and that enables that mobile device to function as a contactless transaction device or proximity payment device. Therefore, in some embodiments, the payment application program 302 is configured to store a plurality of consumer or user financial account information (such as one or more payment card account numbers and associated data that correspond to, for example, credit card accounts, debit card accounts, pre-paid card accounts and the like), and is configured to provide the functionality required for the mobile device to be used as a contactless transaction device. Block 304 represents a payment account selector application that permits a consumer to choose, for example, a particular payment card account from a plurality of payment card accounts available from the electronic wallet for use in any particular transaction. Also depicted in FIG. 3 is an “Authorize My Transaction” application 306 that permits the cardholder to authorize (or decline) transactions that have been flagged as potentially being fraudulent transactions, and that also may be configured to permit the cardholder to pre-authorize transactions, in accordance with the processes disclosed herein.

In addition, other applications 308 may be stored in the memory 206 of the payment-enabled mobile device 200 illustrated in FIG. 2. Such other applications may, for example, control and/or provide functionality associated with the payment controller 226 and/or may include additional functions that are not illustrated in FIG. 3. It should also be understood, however, that in some embodiments of a mobile device memory 206 one or more of the application programs depicted in FIG. 3 may not be present.

In some embodiments, a cardholder may be required to register to participate in an “Authorize My Transaction” system so that, for example, an alerting application may be downloaded to and stored in the memory of the cardholder's mobile device 112, such as a mobile telephone or other device as described above. The cardholder's issuing FI or a third party service provider (PSP) may be responsible for obtaining and storing information concerning the cardholder's mobile device, such as the type of mobile device and/or a mobile telephone number, and for providing the alerting application for loading onto the cardholder's mobile device. As mentioned above, the “Authorize My Transaction” application may include instructions that provide both post-authorization and pre-authorization functionality.

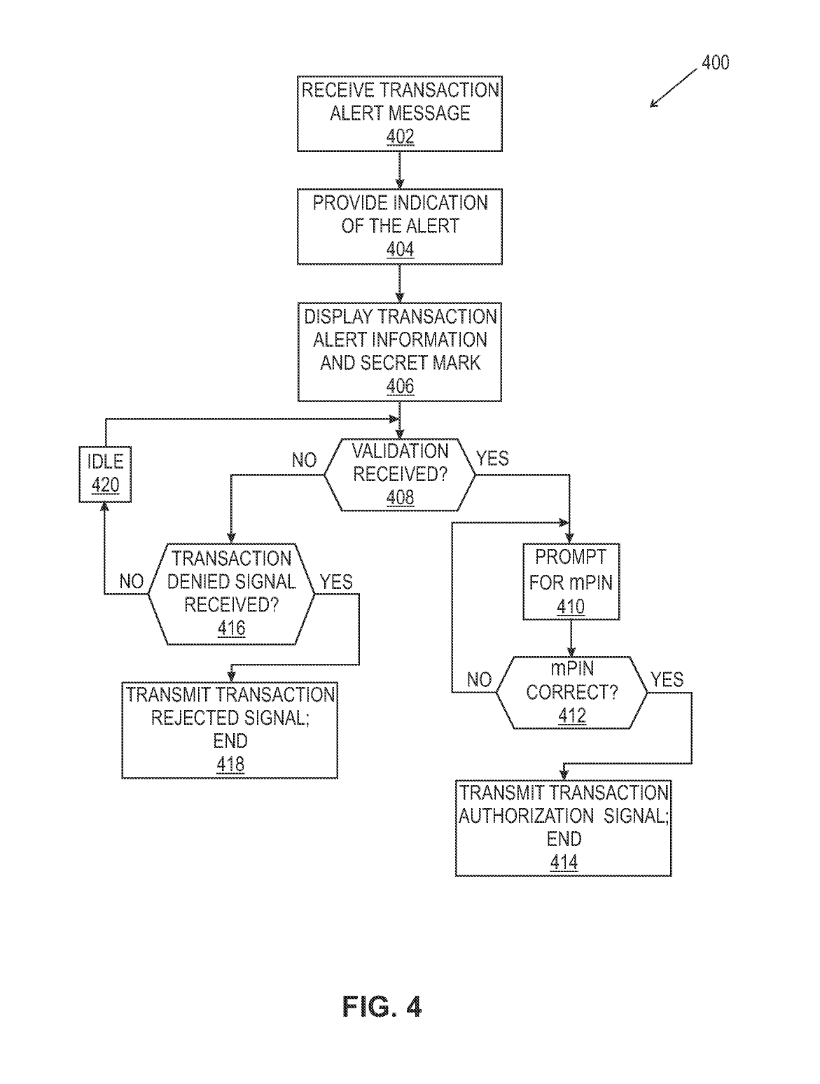

FIG. 4 is a flowchart illustrating a post-authorization process 400 according to an embodiment. When a questionable or potentially fraudulent transaction is flagged by the issuer FI then, according to an implementation, a transaction alert message concerning the dubious transaction is transmitted to the authorization server computer 110 (shown in FIG. 1) for forwarding to the cardholder's mobile device. Referring to FIG. 4, the transaction alert message is received 402 by the cardholder's mobile device, and the device provides 404 a non-intrusive indication to the cardholder regarding the receipt of the transaction alert message. For example, the mobile device may utilize a vibration system 224 to cause the mobile device to vibrate or otherwise move (either continuously or in a predetermined pattern). For example, the non-intrusive indication may include two quick buzz-type vibrations followed by a half-second silent stretch, followed by three quick buzz vibrations and another half-second silent stretch, which pattern repeats itself a predetermined amount of times for a preset period of time, such as twenty seconds overall. Of course, other types of transaction alert indications could be used, including audible indications (such as the use of a special ring tone, nature sound or musical tune that may terminate after a predetermined period of time) and/or visible indications (such powering up a screen of the mobile device to pulse with a particular color light, or with a particular alerting image or message that may terminate after a preset period of time). The cardholder and mobile device owner, in some embodiments, can customize and/or select the type of indication associated with a transaction alert message according to his or her preference(s). Thus, the transaction alert message may be provided by the mobile device to the consumer or cardholder as an audio indication, a visual indication, a tactile indication, and/or a combination of such indications for a period of time that is chosen by the cardholder.

Referring again to FIG. 4, in some embodiments, in response to the transaction alert message, the mobile device automatically powers up to display 406 the transaction alert information along with a secret mark. (However, in some embodiments, the cardholder may be required to touch a button or icon on the touch screen display of the mobile device before any details concerning the transaction alert will be displayed.) The transaction alert information may include descriptive information related to the potentially fraudulent transaction along with two indicators, a “Validate” button or icon and a “Decline” button or icon or the like, for example, for selection by the cardholder. For example, the transaction alert information displayed to the consumer and/or cardholder may include the name of a merchant, a monetary amount of a potentially fraudulent transaction, a currency type, and/or a location of the transaction.

As mentioned above, a secret mark may also be displayed by the mobile device, which secret mark was selected previously by the consumer/cardholder at the time of registration for the “Authorize My Transaction” application. The secret mark may include, but is not limited to a word, a phrase, an alphanumeric code, a color(s), an icon, a picture or photograph, a drawing, a tactile indication, an audio tone(s), some other type of indicator or marking, and/or a combination of such representations and/or indications. Consequently, in some embodiments the secret mark is akin to a password in that it is only known by the issuing financial institution and the cardholder.

Accordingly, when the correct secret mark is displayed and/or presented by the mobile device, if the cardholder can verify that the secret mark is correct then he or she is confident that the transaction alert message originated from the issuer FI and thus that it is legitimate. So if the transaction alert information does not include a secret mark, or if the secret mark is incorrect, then the cardholder/mobile device user recognizes that the transaction alert message itself may be fraudulent. Fraudulent alert messages are commonly known as “phishing” attacks which are used by fraudsters in an attempt to have a cardholder provide sensitive financial account data via a fraudulent website or fraudulent menu that may be displayed on the mobile device. The fraudster then can use any such fraudulently obtained financial information to later commit fraud on that cardholder account. Thus, when the cardholder recognizes such a “phishing” attack, he or she must take care not to provide any information to the fraudster. Instead, the cardholder should contact the issuing FI to report the fraudulent “phishing” attempt and to seek guidance. However, under current practices, when an issuing FI contacts the cardholder, the cardholder generally does not have any convenient way to verify that the contact originated from the issuing FI. Due to the current level and frequency of “phishing” attacks, many cardholders now ignore unexpected communications from issuing financial institutions. Thus, the apparatus, systems and processes disclosed herein provide a means for cardholders to verify that the communication is genuine and originating from the issuing FI. Furthermore, the apparatus, systems and processes disclosed herein provide a communication channel between the cardholder and the issuing FI which is trusted by both parties.

In some embodiments, the secret mark may be stored in the secure element of the consumer's mobile device. For example, the secret mark may be downloaded during a registration process for the Authenticate My Transaction application and stored in the secure element of the mobile device. In this embodiment, when the secret mark is received by the mobile device from the authorization server computer along with the transaction alert information, the mobile device may operate to first ensure that the received secret mark matches the secret mark stored in the mobile device to confirm that the transaction alert message is a true and genuine message from the issuer. In an embodiment, such operation occurs without involving the cardholder, and occurs before providing the non-intrusive indication of a transaction alert message to the cardholder. For example, in some embodiments, the stored secret mark may be encrypted and thus must later be decrypted before a comparison can be made with a downloaded secret mark. Alternately or in addition, the received secret mark from the authorization server computer may be encrypted so that the mobile telephone must utilize one or more forms of cryptography in order to decrypt the received secret mark before making a comparison with the stored secret mark. In some implementations, issuer scripting in the form of post-issuance application management may be performed by the issuer FI, or other methods may be provided such that the mobile device operates to verify the authenticity of the secret mark before bringing the transaction alert message to the attention of the cardholder. In any or all of such implementations, since the mobile telephone operates to verify the received secret mark, the received secret mark may not be displayed or otherwise presented to the cardholder via the mobile device. Instead, the mobile device may display a “secret mark verified” message or the like so that the consumer or cardholder can be confident that the transaction alert message and the accompanying information that is displayed is genuine. Alternately, no such message may be displayed and the transaction alert information may just be displayed because in such cases it is understood by the cardholder (the mobile device owner) that such a secret mark verification process has already occurred in the background or else the transaction alert information would not be presented. But if the received secret mark does not match the secret mark stored in the secure memory, then in an implementation no transaction alert indication or any type of message may be displayed. Instead, in this case the mobile device may automatically log a fraudulent event and report the incident to the issuer FI without involving the cardholder. However, in some other embodiments a “Fraud Alert—Secret Mark Mismatch” message or the like could be displayed by the mobile device to inform the cardholder that a potential “phishing” message was received and that it was reported to the issuing FI.

Referring again to FIG. 4, if the secret mark has been verified in accordance with one or more of the implementations explained herein, and if in step 406 the cardholder recognizes the questionable purchase transaction as being legitimate, then he or she will press the “Validate” button on a touch screen of the mobile device so that the mobile device receives validation 408 of the transaction. The cardholder is then prompted 410 to enter his or her mobile personal identification number (mPIN). The mobile device user may utilize the mobile device's keyboard or touch screen to enter the mPIN in a provided data entry field. The mPIN may be, for example, a 4-digit code that has been selected in advance by the cardholder and that has been stored in a secure element of the mobile device. Thus, the mPIN is only known to the cardholder, and the controller of the mobile device operates to compare the mPIN entered by the cardholder to the data stored in the secure element. If the cardholder enters an incorrect mPIN in step 412 (or if a predetermined amount of time passes without an entry being made), then the process may branch back to step 410 to again prompt the cardholder for the correct mPIN. In some embodiments, if after some predetermined number of tries the correct mPIN is not entered (or if a predetermined time threshold is passed without any entry being made), then the process may time out such that a default mode of operation occurs, which in some implementations is that the issuer FI determines that the potentially fraudulent transaction should be blocked.

Referring again to step 412, if the cardholder/mobile device user enters the correct mPIN, then the mobile device transmits 414 an authorization signal to the authorization server computer 110 (see FIG. 1) for relaying to the issuing FI 106. In this case, the issuing financial institution removes the flag from the dubious transaction and permits that transaction to continue processing in a “business as usual” or normal manner. Such operation thus adds another level of security to the transaction authentication process, both for the cardholder or consumer and for the issuing FI. The consumer is provided with the flexibility to validate what was flagged as a dubious transaction after being notified in an unobtrusive manner (of his or her choosing), and the confidence level is increased of the issuing FI that an originally flagged dubious (and potentially fraudulent) transaction is in fact legitimate.

Referring again to FIG. 4, if in step 408 the cardholder does not recognize the transaction information or the secret mark, he or she may press a “Decline” button so that the mobile device receives 416 a transaction denied signal indicating that the transaction may be fraudulent. In this case, the cardholder's mobile device transmits 418 a transaction rejected signal to the issuing FI via the authorization server so that the issuer FI can block the transaction, and the process ends (with regard to the mobile device). Under such circumstances, since the cardholder has affirmatively identified the transaction as being potentially fraudulent, further processing may occur by the issuing FI to suspend the cardholder's account and/or to escalate the incident to a fraud team (for example, before closing the cardholder's financial account). In addition, in some embodiments, the issuer FI may determine that the cardholder must be contacted via telephone or email to gather more facts or information concerning the circumstances of the fraudulent transaction before taking any further actions, for example, to determine whether the cardholder's credit card was lost or stolen.

Returning now to step 408, if a validation indication is not received and then a transaction denied indication is not received in step 416, the process may idle 420 for a predetermined period of time before the process branches back to step 408 to again check if either such indication was received. If the predetermined idle period expires, then in some embodiments the process may time out and then a default mode of operation occurs. The default mode of operation may include the issuer FI blocking the potentially fraudulent transaction and/or suspending the cardholders' account. The issuing FI may then take subsequent action(s) to attempt to contact the cardholder, for example via e-mail and/or a telephone call to a home telephone number of the cardholder, so as to obtain further information regarding the potentially fraudulent transaction and/or to reinstate the cardholder's account.

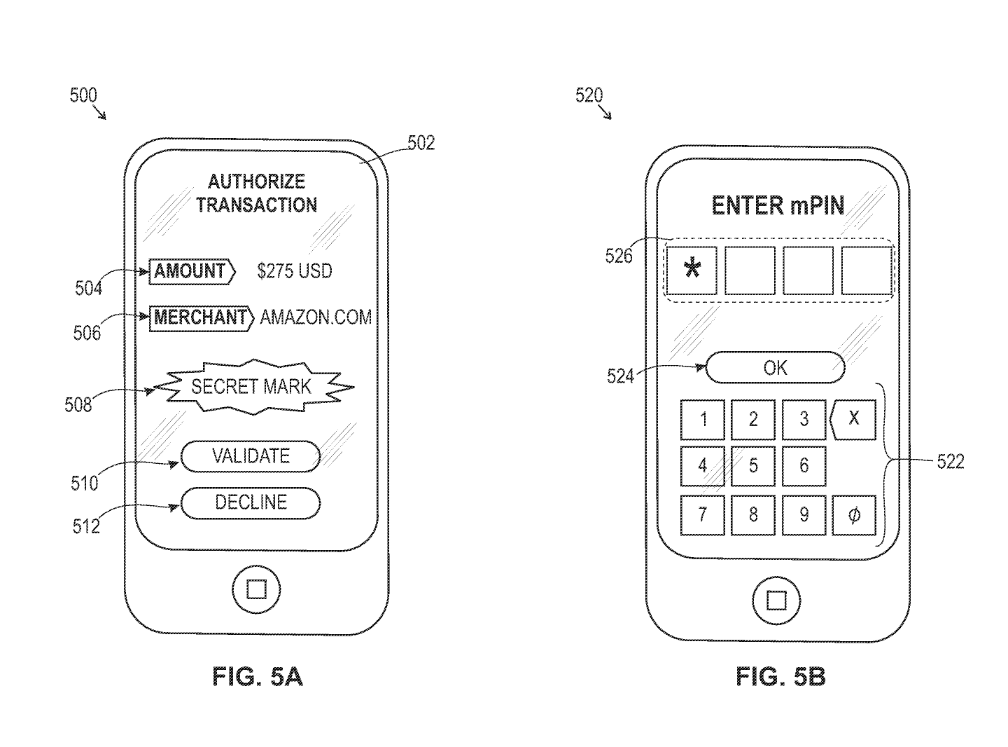

FIGS. 5A and 5B illustrate examples of screen shots 500 and 520 shown on a display screen 502 of a cardholder's mobile device with regard to a post-authorization mode of operation according to an embodiment. In particular, FIG. 5A shows an “Authorize Transaction” message on the cardholder's mobile telephone display that represents transaction alert information of what the issuing FI considers to be a potentially fraudulent transaction. The “Authorize Transaction” message may be transmitted and received in substantially real-time, meaning immediately after the potentially fraudulent transaction has occurred or is occurring. In this example, the transaction alert information includes a transaction amount 504 of $275 U.S. dollars, a merchant name 506 indicating “Amazon.com™”, and a secret mark 508. (In some implementations, a time and date of the transaction may also be displayed.) Also shown are a “Validate” button 510 and a “Decline” button 512. If the cardholder/mobile device owner presses the “Validate” button, then the mobile device displays the validation screen 520 shown in FIG. 5B. The validation screen prompts the cardholder for entry of a secret mPIN by utilizing the touch screen keypad 522 and then pressing the “Ok” button 524. As the cardholder enters the four-digit mPIN, the entries appear in entry fields 526, which may be obscured for security reasons. After entry of the mPIN and pressing the “OK” button, the mobile device compares the entered data to the mPIN stored in a secure area of the mobile device, and if a match occurs then the mobile device transmits a validation signal to the authorization server. The process then proceeds as explained above with regard to FIGS. 1 and 4. Of course, if the cardholder/mobile device owner had instead pressed the “Decline” button 512 (see FIG. 5A), then in some implementations the display 520 would not appear and instead a decline signal would be sent directly to the authorization server for further processing. However, in some embodiments, after detection of selection of the “Decline” button 512, the display 520 does appear requiring the cardholder/mobile device owner to enter his or her mPIN for validation before a decline signal is transmitted from the mobile device to the authorization server.

In some embodiments the “Authorize My Transaction” application downloaded to the cardholder's mobile device may also be operable to permit the cardholder to provide advance warning (pre-authorization) to the issuing FI of a future or upcoming purchase that the cardholder believes might be flagged as a potentially fraudulent transaction. For example, if the cardholder is planning to or intends to buy an expensive leather sectional sofa for his home utilizing a particular payment card account, the cardholder can utilize the “Authorize My Transaction” application on his or her mobile device to enter information into a “pre-authorization” menu. The pre-authorization menu may include fields for providing, for example, the merchant's name, the merchant's retail store location or website address, the merchandise type (such as a make, model name, and/or a description and the like), the purchase price, and the future date of the purchase. The cardholder can then use his or her mobile device to transmit the pre-authorization information to the issuer FI via the authorization server for storage in a “pre-authorization” database such that it is associated with that cardholder's account. Thus, when the purchase transaction for the leather sofa occurs, the issuing FI checks the pre-authorization database for any pre-authorization information associated with that cardholder's account. In some embodiments, the issuing FI may ensure that a minimum threshold amount of the purchase transaction data matches the pre-authorization data provided by the cardholder from his or her mobile device. If so, then the issuing FI does not transmit a transaction alert message and instead continues with normal processing to either authorize the transaction or deny the transaction (for example, based on the creditworthiness of the cardholder). In some implementations, the issuing FI may also transmit an SMS message (or another type of message) to the cardholder's mobile device acknowledging the occurrence of the pre-authorized transaction.

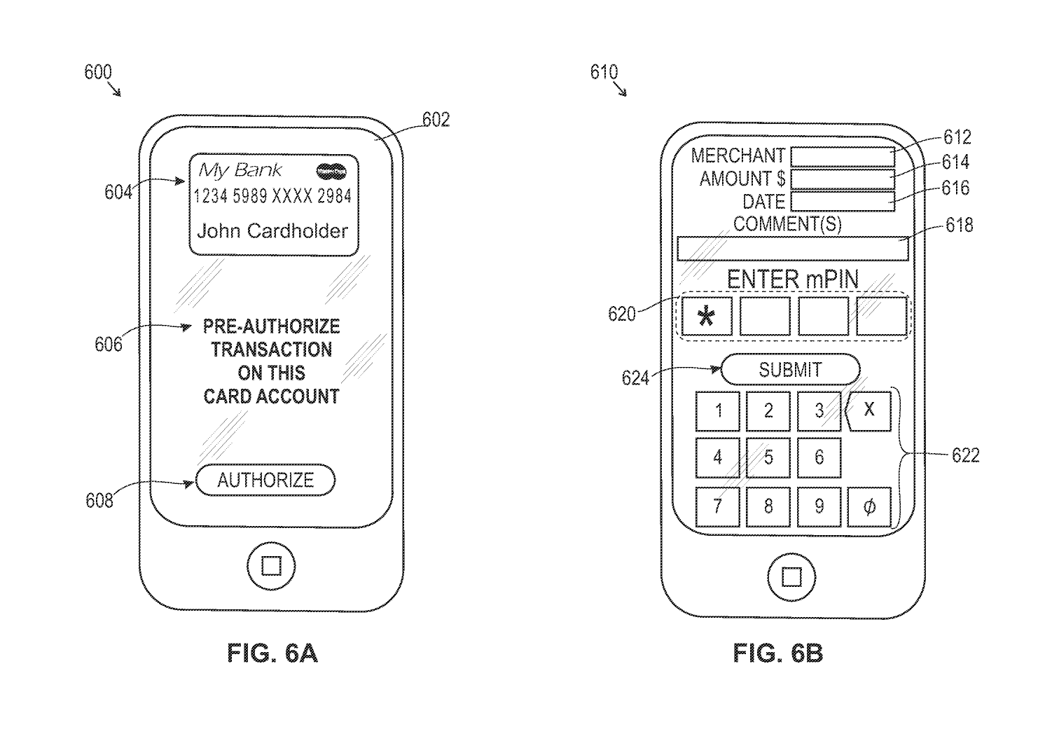

FIGS. 6A and 6B illustrate examples of screen shots 600 and 610 shown on a display screen 602 of a cardholder's mobile device with regard to a pre-authorization mode of operation according to an embodiment. In particular, FIG. 6A shows a graphic representation of a credit card 604 that includes the cardholder's credit account information with a message 606 stating “Pre-Authorize Transaction On This Card Account” along with an “Authorize” button 608. The particular credit card account that is shown may have been preselected by the cardholder/mobile device owner, or may otherwise have been selected by the mobile device owner, for example, from a mobile wallet containing information relating to several different accounts. If the mobile device owner/cardholder presses the “Authorize” button 608, then mobile device displays the pre-authorization data screen 610 shown in FIG. 6B. The pre-authorization screen includes data fields for the mobile device user to provide the name of the merchant 612, the amount of the purchase transaction 614 (in this example, in U.S. dollars, but other currency types such as Euros could be entered), the date 616 of the transaction, and any comments 618 that the cardholder wishes to provide. (It should be understood that, when the cardholder touches any of the fields 612-618, an alphanumeric keyboard may then appear or be provided on a bottom portion of the screen for use by the cardholder/mobile device owner to enter the required data.) The pre-authorization data screen 610 also includes mPIN data entry fields 620, a touch screen numeric keyboard 622 and a “Submit” button 624.

After entry of the required purchase transaction data in fields 612-618, the cardholder enters the four-digit mPIN and the entries appear in entry fields 620 and, as explained above, the mPIN entries may be obscured for security reasons. After entry of the mPIN and pressing the “Submit” button 624, the mobile device compares the entered mPIN data to that stored in a secure area of the mobile device, and if a match occurs then the mobile device transmits the pre-authorization data to the authorization server. The process then proceeds as explained above with the pre-authorization information being forwarded to the issuer FI via the authorization server for storage in a “pre-authorization” database such that it is associated with that cardholder's account. When the purchase transaction then occurs with the designated merchant for the designated amount on the designated date, then the issuing FI will find that there is a match for the transaction in the pre-authorization database for the cardholder's account. The issuing FI then does not flag that transaction as being potentially fraudulent and does not transmit a transaction alert message. Instead, normal processing occurs to either authorize the transaction or deny the transaction (for example, based on the creditworthiness of the cardholder). In some implementations, the issuing FI may also transmit an SMS message (or another type of message) to the cardholder's mobile device acknowledging the occurrence of the pre-authorized transaction.

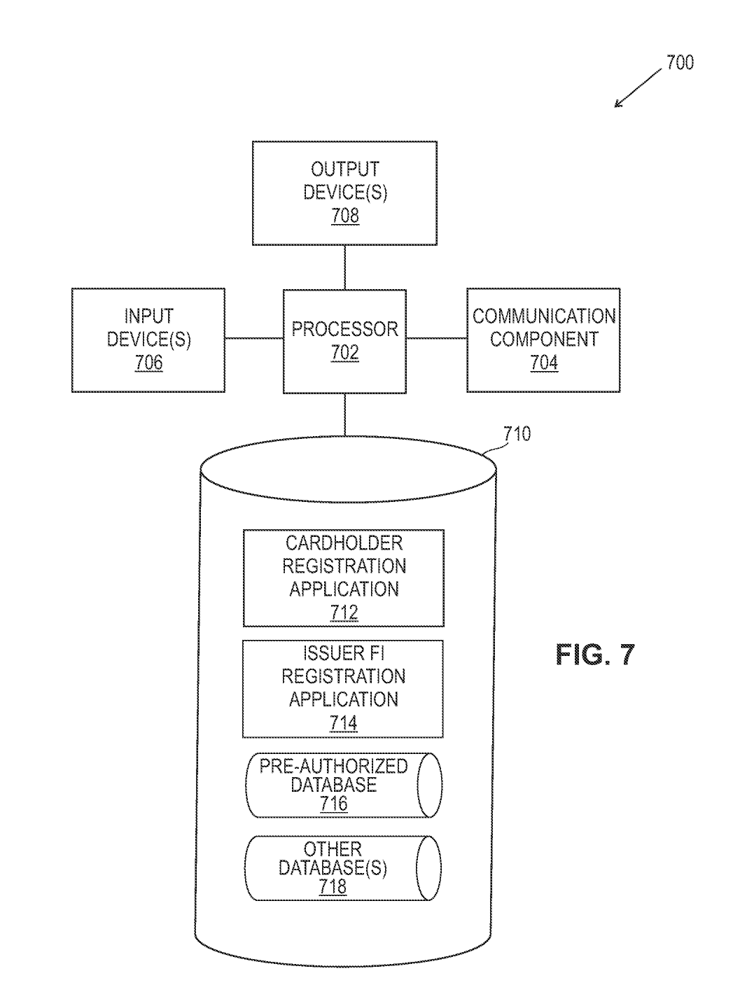

FIG. 7 is a block diagram of an embodiment of an authorization server computer 700. The authorization server computer 700 may be conventional in its hardware aspects but may be controlled by software to cause it to operate in accordance with aspects of the methods presented herein. In particular, the authorization server computer 700 may include a computer processor 702 operatively coupled to a communication component 704, an input device 706, an output device 708, and a storage device 710.

The computer processor 702 may constitute one or more conventional processors. Processor 702 operates to execute processor-executable steps, contained in program instructions described herein, so as to control the authorization server computer 700 to provide desired functionality.

Communication device 704 may be used to facilitate communication with, for example, other devices and/or server computers (such as for receiving data via the Internet or via a mobile network operator from a consumer mobile device and for transmitting data to the consumer mobile device). Communication device 704 may also, for example, have capabilities for engaging in data communications over conventional computer-to-computer data networks, in a wired or wireless manner. Such data communications may be in digital form and/or in analog form.

Input device 706 may comprise one or more of any type of peripheral device typically used to input data into a computer. For example, the input device 706 may include a keyboard and a mouse and/or a touchpad that may be used, for example, by a systems engineer or other personnel authorized to, for example, perform server computer system maintenance or other task. The output device 708 may comprise, for example, a display and/or a printer.

Storage device 710 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as flash memory devices. Any one or more of the listed storage devices may be referred to as a “computer readable medium”, “memory”, “storage” or a “storage medium”.

Storage device 710 stores one or more programs for controlling processor 702. The programs comprise program instructions that contain processor-executable process steps of the authorization server computer 700, including, in some cases, process steps that constitute processes provided in accordance with principles of the processes presented herein.

The programs may include a cardholder registration application 712 that manages a process wherein consumers register themselves and their consumer mobile device(s) for the “Authorize My Transaction” services which may include the post-transaction process and the pre-authorization process, as described herein. In some embodiments, the cardholder registration application may allow consumers to register one or more payment accounts with the authorization server by accessing, for example via their mobile telephone or tablet computer or laptop computer, a suitable web page hosted by the authorization server computer. The information obtained from the consumer during the registration process may include the consumer's name, residence address, email address, one or more primary payment account numbers (PANs), a mobile telephone number (or other mobile identifier), an e-mail address, and consumer mobile device information. In some embodiments, the application programs may also include an issuer FI registration application 714 that manages a process by which issuing FI's register with the authorization server in order to offer the “Authorize My Transaction” service to consumers/cardholders. In some implementations, issuing FI's register by accessing an issuer FI registration web page from an authorization server computer website that includes an issuing FI interface for providing required information.

The storage device 710 may also include a “Pre-Authorization” database 716 for storing pre-authorization transaction data provided by cardholders and for use by issuer FI's, as explained above. In addition, one or more other databases 718 may be maintained by the authorization server computer 700 on the storage device 710. Among these databases may be, for example, a cardholder registration information database, an issuer FI registration information database, and the like.

The application programs of the wallet server computer 700, as described above, may be combined in some embodiments, as convenient, into one, two or more application programs. Moreover, the storage device 710 may store other programs or applications, such as one or more operating systems, device drivers, database management software, web hosting software, business intelligence software (for example, to determine analytics which may be useful to merchants), and the like.

As the term “payment transaction” is used herein and in the appended claims, it should be understood to include the types of transactions commonly referred to as “purchase transactions” that may involve payment card accounts and/or payment card systems. The purchase transactions may be in connection with traditional point-of-sale (POS) transactions that may occur in a merchant's retail locations, or may be eCommerce transactions that occur through use of the internet.

The term “storage device” as used herein and in the appended claims may include any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as flash memory devices. Any one or more of the listed storage devices may be referred to as a “computer readable medium”, “memory”, “storage” or a “storage medium”. In addition, it should be understood that the term non-transitory computer-readable media or non-transitory computer readable medium includes all computer-readable media, with the sole exception being a transitory, propagating signal.

The above descriptions and illustrations of processes herein should not be considered to imply a fixed order for performing the process steps. Rather, the process steps may be performed in any order that is practicable, including simultaneous performance of at least some steps.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
receiving, by a mobile device of a cardholder, a transaction alert message concerning a potentially fraudulent transaction;
providing, by the mobile device, an indication of the transaction alert message;
displaying, by the mobile device, transaction alert information concerning the potentially fraudulent transaction, a validate indicator, and a decline indicator;
receiving a selection of the validate indicator;
prompting the cardholder to enter a mobile personal identification number (mPIN) to authorize the potentially fraudulent transaction;
validating, by the mobile device, the mPIN; and
transmitting, by the mobile telephone, a validation signal to an issuer financial institution.

2. The method of claim 1, further comprising, prior to displaying the transaction alert information, receiving an indication from the cardholder to display the transaction alert information.

3. The method of claim 1, wherein providing the indication of the transaction alert message comprises at least one of providing an audio indication, a visual indication and a tactile indication.

4. The method of claim 1, wherein the transaction alert information comprises at least two of the name of a merchant, a monetary amount of the transaction, a currency type, a date of the transaction, a time of the transaction, and a location.

5. The method of claim 1, further comprising, subsequent to displaying the transaction alert information:
receiving a selection of the decline indicator; and
transmitting, by the mobile device to an authorization server computer, a transaction rejection signal.

6. The method of claim 1, wherein receiving the transaction alert message further comprises:
receiving, by the mobile device, a secret mark; and
displaying the secret mark with the transaction alert information.

7. The method of claim 6, wherein the secret mark comprises at least one of a word, a phrase, an alphanumeric code, a picture, a tactile indication, and an audio tone.

8. The method of claim 6, further comprising,
receiving a selection of the decline indicator; and
transmitting, by the mobile device to an authorization server computer, a transaction rejection signal.

9. The method of claim 1, further comprising, prior to providing an indication of the transaction alert message:
receiving, by the mobile device, a secret mark;
determining, by the mobile device, that the received secret mark matches a secret mark stored in a secure element of the mobile device; and
enabling the display of the transaction alert information.

10. The method of claim 9, further comprising presenting, by the mobile device, at least one of the received secret mark and an indication that the secret mark was authenticated.

11. The method of claim 9, wherein the secret mark comprises at least one of a word, a phrase, an alphanumeric code, a picture, a tactile indication, and an audio tone.

12. The method of claim 9, wherein determining that the received secret mark matches the stored secret mark comprises:
decrypting, by the mobile device, the received secret mark; and
comparing the decrypted secret mark to the stored secret mark.

13. The method of claim 1, further comprising, prior to providing an indication of the transaction alert message:
receiving, by the mobile device, a secret mark;
determining that the received secret mark does not match a secret mark stored in a secure element; and
preventing, by the mobile device, the display of the transaction alert information.

14. The method of claim 13, further comprising at least one of notifying, by the mobile device, the issuer financial institution of an occurrence of a fraudulent event, and presenting a fraud alert message on the mobile device.

15. The method of claim 13, further comprising logging, by the mobile device, a fraudulent event indication.

16. A non-transitory computer-readable medium storing instructions configured to cause a processor to:
receive a transaction alert message concerning a potentially fraudulent transaction;
provide an indication of the transaction alert message;
display transaction alert information concerning the potentially fraudulent transaction, a validate indicator, and a decline indicator;
receive a selection of the validate indicator;
prompt a cardholder to enter a mobile personal identification number (mPIN) to authorize the potentially fraudulent transaction;
validate the mPIN; and
transmit a validation signal to an issuer financial institution.

17. The non-transitory computer-readable medium of claim 16, further comprising, prior to the instructions to display the transaction alert information, instructions configured to cause the processor to receive an indication from the cardholder to display the transaction alert information.

18. The non-transitory computer-readable medium of claim 16, wherein the instructions for providing the indication of the transaction alert message further comprises instructions configured to cause the processor to at least one of provide an audio indication, a visual indication and a tactile indication.

19. The non-transitory computer-readable medium of claim 16, further comprising, prior to the instructions for receiving the selection of the validate indicator, instructions configured to cause the processor to:
receive a selection of the decline indicator; and
transmit a transaction rejection signal to an authorization server computer.

20. The non-transitory computer-readable medium of claim 16, wherein the instructions for receiving the transaction alert message further comprises instructions configured to cause the processor to:
receive a secret mark; and
display the secret mark with the transaction alert information.

21. The non-transitory computer-readable medium of claim 20, further comprising instructions configured to cause the processor to:
receive a selection of the decline indicator; and
transmit a transaction rejection signal to an authorization server computer.

22. The non-transitory computer-readable medium of claim 16, wherein the instructions for receiving the transaction alert message further comprises instructions configured to cause the processor to:
receive a secret mark;
determine that the received secret mark matches a secret mark stored in a secure element of the mobile device; and
enable the display of the transaction alert information.

23. The non-transitory computer-readable medium of claim 22, further comprising instructions configured to cause the processor to present at least one of the received secret mark and an indication that the secret mark was authenticated.

24. The non-transitory computer-readable medium of claim 22, wherein the instructions for determining that the received secret mark matches the stored secret mark further comprises instructions configured to cause the processor to:
decrypt the received secret mark; and
compare the decrypted secret mark to the stored secret mark.

25. The non-transitory computer-readable medium of claim 16, further comprising, prior to providing an indication of the transaction alert message, instructions configured to cause the processor to:
receive a secret mark;
determine that the received secret mark does not match a secret mark stored in a secure element; and
prevent the display of the transaction alert information.

26. The non-transitory computer-readable medium of claim 25, further comprising instructions configured to cause the processor to at least one of notify an issuer financial institution of an occurrence of a fraudulent event, and present a fraud alert message on the mobile device.

27. The non-transitory computer-readable medium of claim 25, further comprising instructions configured to cause the processor to log a fraudulent event indication.

28. A mobile device, comprising:
a processor;
a transceiver operably connected to the processor; and
a storage device operably connected to the processor, wherein the storage device stores an authorize my transaction application that includes instructions configured to instruct the processor to:
receive a transaction alert message concerning a potentially fraudulent transaction;
provide an indication of the transaction alert message;
display transaction alert information concerning the potentially fraudulent transaction, a validate indicator, and a decline indicator;
receive a selection of the validate indicator;
prompt a cardholder to enter a mobile personal identification number (mPIN) to authorize the potentially fraudulent transaction;
validate the mPIN; and
transmit a validation signal.

29. A system, comprising:
an issuing financial institution (FI) computer including an electronic anti-fraud system;
an authorization computer operably connected to the issuing FI computer and configured to receive transaction alert messages from the issuing FI and to transmit the transaction alert messages; and
a mobile device of a cardholder, the mobile device comprising a processor, a transceiver and a storage device, wherein the storage device includes an authorize my transaction application including instructions configured to instruct the processor to:
receive a transaction alert message from the authorization computer concerning a potentially fraudulent transaction;
provide an indication of the transaction alert message;
display transaction alert information concerning the potentially fraudulent transaction, a validate indicator, and a decline indicator;
receive a selection of the validate indicator;
prompt a cardholder to enter a mobile personal identification number (mPIN) to authorize the potentially fraudulent transaction;
validate the mPIN; and
transmit a validation signal to the aut issuing FI computer.
